(19) United States
(12) Patent Application Publication
(10) Pub. No.: US 2013/0135998 A1
(43) Pub. Date: May 30, 2013

(54) Techniques to Reduce Congestion in a Core Network and Other Elements Within a Wireless Network

(71) Applicant: Nokia Siemens Networks Oy, Espoo (FI)

(72) Inventor: Shahab Sayeedi, Naperville, IL (US)

(73) Assignee: Nokia Siemens Networks Oy, Espoo (FI)

(21) Appl. No.: 13/690,053

(22) Filed: Nov. 30, 2012

Related U.S. Application Data
(60) Provisional application No. 61/565,459, filed on Nov. 30, 2011.
(60) Provisional application No. 61/578,383, filed on Dec. 21, 2011.

(51) Int. Cl. H04W 28/02

(52) U.S. Cl. CPC H04W 28/0289
USPC 370/230

(57) ABSTRACT

A method includes receiving, by a RAN providing service to access terminal(s) and supporting a packet data session for each of the access terminal(s) wherein each packet data session is associated with a subscription priority, a message including a priority field and requesting release of all packet data sessions having a subscription priority meeting one or more priority criteria corresponding to the priority field, and releasing all packet data sessions with a subscription priority not meeting the one or more priority criteria. Another method includes terminating by a gateway entity a packet data session for access terminal(s), wherein each packet data session is associated with a subscription priority; and sending by the gateway entity a message comprising a priority field requesting release of all packet data sessions associated with a subscription priority meeting one or more priority criteria corresponding to the priority field. Apparatus and program products are also disclosed.

### CROSS-REFERENCE TO RELATED ED APPLICATIONS

The present application claims the benefit under 35 U.S.C. §119(e) of U.S. Provisional Patent Application No. 61/565,459, filed on Nov. 30, 2011, and of U.S. Provisional Patent Application No. 61/578,383, filed on Dec. 21, 2011, the disclosures of each which are hereby incorporated by reference in their entirety.

### TECHNICAL FIELD

This invention relates generally to wireless networks and, more specifically, relates to reducing congestion in a core network and other elements within the wireless network.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

The following abbreviations that may be found in the specification and/or the drawing figures are defined as follows:

3GPP third generation partnership project

AI access interface

AN access network

AT access terminal

AAA authentication, authorization and accounting

APN access provider network

BS base station

CDMA code division multiple access

CN core network

eAN evolved AN

eHRPD evolved HRPD

eNB or eNodeB evolved Node B/base station in an E-UTRAN System

E-UTRA evolved universal terrestrial radio access

E-UTRAN evolved UTRAN (LTE)

GRE generic routing encapsulation

HA home agent

HRPD high rate packet data

HSGW HRPD serving gateway

HSS home subscriber server

IOS interoperability specification

IWS interworking solution

LTE long term evolution

LTE-A long term evolution advanced

M2M machine-to-machine

MME mobility management entity

MSC mobile switching center

MSCe MSC emulation

PCF packet control function

PDSN packet data serving node

PGW packet data network gateway

RAN radio access network

RT radio transceiver

SC/MM session control and mobility management

SGW serving gateway

UTRAN universal terrestrial radio access network

Core network congestion may prevent an access terminal from connecting to an APN and even cause wireless network failure. In particular, this may occur when large numbers of access terminals attempt to access a network simultaneously. Overload of some network resources result in false authentication failures. Large numbers of simultaneous re-connect attempts makes the congestion worse. It would be beneficial to reduce certain traffic associated with this congestion.

### SUMMARY

This section contains examples of possible implementations and is not meant to be limiting.

In an example, a method is disclosed that includes receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and releasing, by the radio access network in response to the received message, all packet data sessions with a subscription priority not meeting the one or more priority criteria.

Another example is a computer program comprising program code for executing the method of the previous paragraph. A further example is a computer program product according to this paragraph, wherein the computer program is a computer program product comprising a computer-readable medium bearing computer program code embodied therein for use with a computer.

In another example, an exemplary apparatus includes one or more processors and one or more memories including computer program code. The one or more memories and the computer program code are configured to, with the one or more processors, cause the apparatus to perform at least the following: receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and releasing, by the radio access network in response to the received message, all packet data sessions with a subscription priority not meeting the one or more priority criteria.

An additional exemplary embodiment is a exemplary computer program product that includes a computer-readable medium bearing computer program code embodied therein for use with a computer. The computer program code includes: code for receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and code for releasing, by the radio access network in response to the received message, all packet data sessions with a subscription priority not meeting the one or more priority criteria.

Yet another example is an apparatus including: means for receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and means, in the radio access network and responsive to the received message, for releasing all packet data sessions with a subscription priority not meeting the one or more priority criteria.

A further example is a method comprising: terminating by a gateway entity a packet data session for each of one or more access terminals, wherein each packet data session is associated with a subscription priority; and sending by the gateway entity a message comprising a priority field requesting release of all packet data sessions associated with a subscription priority meeting one or more priority criteria corresponding to the priority field.

Another example is a computer program comprising program code for executing the method of the previous paragraph. A further example is a computer program product according to this paragraph, wherein the computer program is a computer program product comprising a computer-readable medium bearing computer program code embodied therein for use with a computer.

An exemplary apparatus includes one or more processors and one or more memories including computer program code. The one or more memories and the computer program code are configured to, with the one or more processors, cause the apparatus to perform at least the following: terminating by a gateway entity a packet data session for each of one or more access terminals, wherein each packet data session is associated with a subscription priority; and sending by the gateway entity a message comprising a priority field requesting release of all packet data sessions associated with a subscription priority meeting one or more priority criteria corresponding to the priority field.

An exemplary computer program product includes a computer-readable medium bearing computer program code embodied therein for use with a computer. The computer program code includes: code for terminating by a gateway entity a packet data session for each of one or more access terminals, wherein each packet data session is associated with a subscription priority; and code for sending by the gateway entity a message comprising a priority field requesting release of all packet data sessions associated with a subscription priority meeting one or more priority criteria corresponding to the priority field.

An additional exemplary embodiment is an apparatus comprising: terminating by a gateway entity a packet data session for each of one or more access terminals, wherein each packet data session is associated with a subscription priority; and sending by the gateway entity a message comprising a priority field requesting release of all packet data sessions associated with a subscription priority meeting one or more priority criteria corresponding to the priority field.

### BRIEF DESCRIPTION OF THE DRAWINGS

In the attached Drawing Figures:

FIGS. 1 and 2 are block diagram of an access terminal in communication with an exemplary wireless network and interfaces between elements in the network;

FIGS. 3-7 are exemplary process diagrams for reducing congesting in core networks and other elements within wireless networks; and

FIG. 8 is a block diagram of another exemplary system in which the exemplary embodiments may be practiced.

### DETAILED DESCRIPTION OF THE DRAWINGS

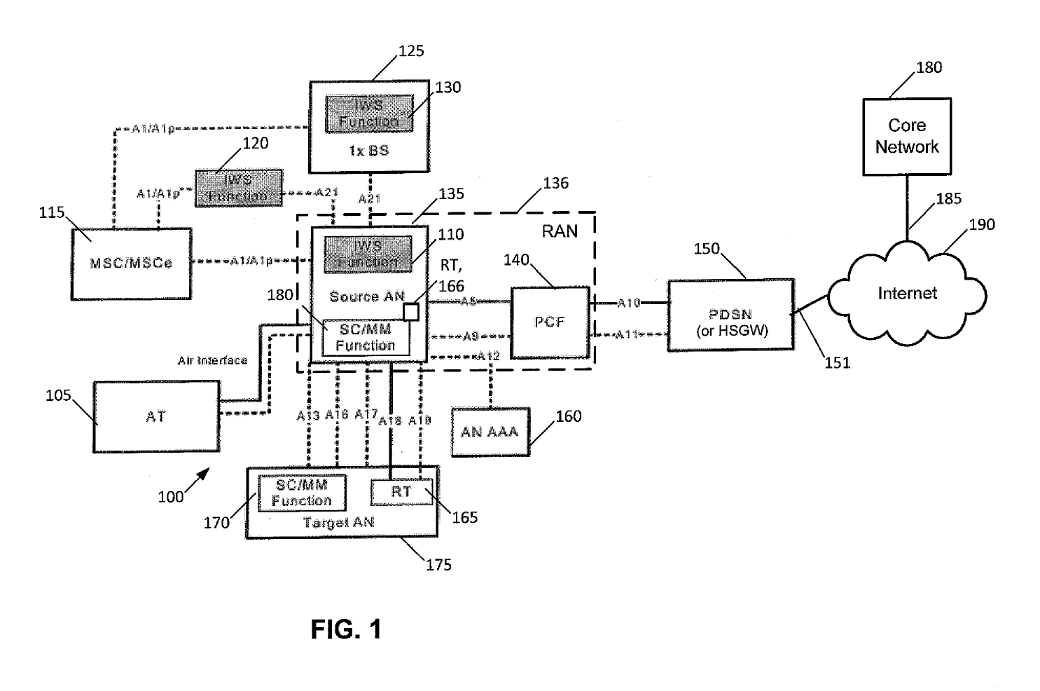

Before proceeding with additional description of CN congestion problems, several exemplary wireless networks are first presented. FIG. 1 shows a block diagram of an access terminal in communication with an exemplary wireless network 100 and interfaces between elements in the wireless network. An access terminal 105 communicates with a wireless network 100. The wireless network 100 includes an MSC/MSCe 115, a base station 125, a source AN 135, a target AN 175, an AN AAA 160, a PCF 140, and a PDSN (or HSGW) 150. The Packet Data Serving Node, or PDSN, is a component of a CDMA2000 mobile network. The PDSN acts as the connection point between the radio access and IP (Internet Protocol) networks. This component is responsible for managing PPP (point-to-point protocol) sessions between the mobile provider's core IP network and the mobile station (e.g., mobile phone), which is one version of an AT.

There are a number of possible IWS functions 120, 130, and 110. There are two SC/MM functions 170, 180. The SC/MM function is in the ANs (source and target) in this architecture. The source AN 136 includes one or more RTs 166. In the target AN 175, there is also an RT 165. The PDSN or HSGW 150 is connected to a core network 180 via the Internet 190. The PDSN or HSGW 150 is connected to the Internet 190 via one or more links 151 and the Internet 190 is connected to the core network via one or more links 185. The PDSN or HSGW 150 is a gateway entity providing a gateway for the source AN(s) 135 to the core network 180. A RAN 136 includes the PCF 140 and the source AN 135 in this example. The source AN may be considered to be a base station. FIG. 1 is similar to FIG. 1.4-1 (“HRPD IOS Architecture Reference Model (SC/MM in the AN)”) shown in 3GPP2 A.S0008-C v4.0 (April 2011), entitled “Interoperability Specification (IOS) for High Rate Packet Data (HRPD) Radio Access Network Interfaces with Session Control in the Access Network”.

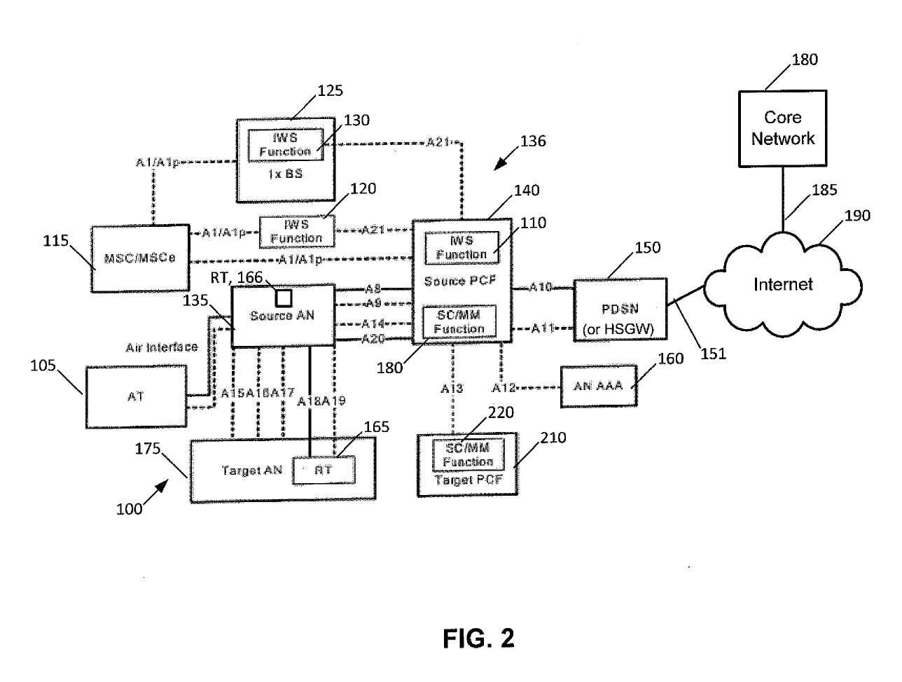

FIG. 2 shows a block diagram of an access terminal in communication with an exemplary wireless network 100 and interfaces between elements in the wireless network. Most of the elements in wireless network 100 have been described above in reference to FIG. 1, and only differences are described for FIG. 2. The RAN 136 includes the source PCF 140 and the source AN 135. The target AN 175 in FIG. 2 does not include the SC/MM function 170. Instead, the source PCF 140 includes the SC/MM function 180 and the target PCF 210 includes the SC/MM function 220. The SC/MM function is in the PCFs (source and target) in this architecture. FIG. 2 is similar to FIG. 1.4-1 (“HRPD IOS Architecture Reference Model (SC/MM in the PCF)”) shown in 3GPP2 A.S0009-C v4.0 (April 2011), entitled “Interoperability Specification (IOS) for High Rate Packet Data (HRPD) Radio Access Network Interfaces with Session Control in the Packet Control Function”.

The core network may include Home Agents (HAs), AAA, APN, and the like.

Returning to problems associated with core network congestion, as stated above, core network congestion has in the past prevented an access terminal 105 from connecting to an APN (e.g., in core network 180) and has resulted in network failure. In one known case, an error occurred between an SGW and PGW and caused many LTE connections (e.g., LTE-Uu) from the CN to access terminals 105 to be dropped. When large numbers of access terminals 105 attempted to re-connect via LTE, false authentication failure occurred due to HSS overload. Dual-mode access terminals 105 then attempted access via eHRPD (e.g., via the AN 135, which can be an eAN connected to the HSGW 150), which also falsely failed authentication due to related HSS/AAA overload.

One network-based solution for these types of overloads is to route traffic away from eHPRD to legacy HRPD via, e.g., the PDSN 150 (or HSGW 150). The present disclosure includes techniques for a PDSN/HSGW 150 to inform an HRPD/eHRPD access network of network congestion, which may be used, e.g., to effectuate this routing.

In exemplary embodiments, the instant invention provides solutions to quickly and gracefully reduce PDSN/HSGW traffic and/or core network traffic. These solutions require no HRPD air interface (AI) changes and therefore facilitate a quick deployment of the feature to address this serious network congestion problem, which is occurring in some operator networks. Exemplary embodiments of the invention can also be used to gracefully reduce the explosion of network traffic expected, e.g., as M2M (machine-to-machine) devices are increasingly deployed.

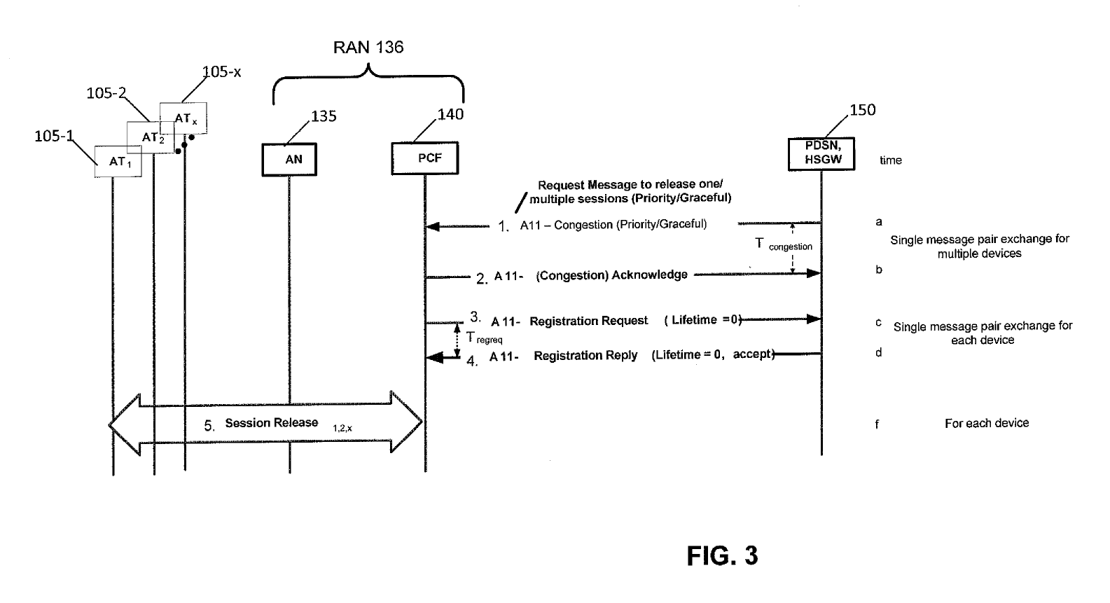

An exemplary solution requires a single message to be sent from the PDSN/HSGW 150 over the A11 signaling interface to a PCF 140 (e.g., integrated within RAN 136) instructing the PCF 140 (or the RAN 136) to initiate release of one or multiple packet data sessions having a packet data session priority or subscriber class of service lower than a priority or class of service indicated in the message, while allowing existing higher priority sessions to continue operating. This is shown in FIG. 3, where the PDSN/HSGW 150 sends (operation 1) a congestion message (“Congestion”) or a message indicating congestion (e.g., a “Request Message” to release one or more multiple packet data sessions) including indications of “priority” and “graceful” if the radio access network supports congestion relief procedures proposed by an exemplary embodiment of this invention. The indication of “priority” may be a priority criterion having a value. The “graceful” indication (or lack of the indication, such that the default situation is a graceful release of each packet data session) indicates to the RAN 136 that the PCF should perform an exchange of Registration Request and Reply messages (see operations 3 and 4) with the gateway entity (PDSN or HSGW 150) corresponding to a session to be released, the exchange indicating to the PDSN/HSGW 150 that that session and its corresponding A10 connections are to be released. The PDSN/HSGW in response to the A11-Registration Request messages releases the A10 connections associated with the session and responds with the A11-Registration Reply message. The PPP connection between the PDSN/HWGW in the case of HRPD is also released.

The RAN 136 sends an acknowledge message (e.g., for congestion or responsive to the request) in operation 2. The Tcongestion is a timer set by the PDSN/HSGW 150. The operations 3 and 4 are single message pair exchanges for each device (i.e., each AT 105) having a session that is to be removed. That is, one pair exchange (operation 3 and 4) will be performed for each to-be-released session, so that if 10 sessions are to be removed, 10 pair exchanges are performed. The Tregreq is a timer set by the RAN 136. In operation 5, the RAN 136 performs session releases for all sessions not meeting the priority criterion. In an exemplary embodiment, the priority indication (“priority”) indicates a priority and the RAN 136 releases all sessions (and corresponding ATs 105) having priorities equal to or below the priority. Operation 5 includes signaling between the RAN 136, the AN 135, and each of the ATs 105 (i.e., for each device).

Concerning the All interface, this interface carries signaling information between the RAN 136 and the PDSN 150. The A10 interface carries bearer traffic for the AT between the RAN 136 and the PDSN 150 For A11 descriptions, refer to section 2.3 of 3GPP2 A.S0008-C v4.0 or 3GPP2 A.S0009-C v4.0. Section 2.3 refers to A.S0017-C v3.0, Interoperability Specification (IOS) for cdma2000 Access Network 42 Interfaces—Part 7 (A10 and A11 Interfaces), September 2010. See 3GPP2 A.S0017-D v3.0, “Interoperability Specification (IOS) for cdma2000 Access Network Interfaces—Part 7 (A10 and A11 Interfaces)”, (3G-IOS v5.1.2), which is an updated version of A.S0017. A11 interface changes required for HRPD are specified in Annex D of 3GPP2 A.S0008-C v4.0 or 3GPP2 A.S0009-C v4.0.

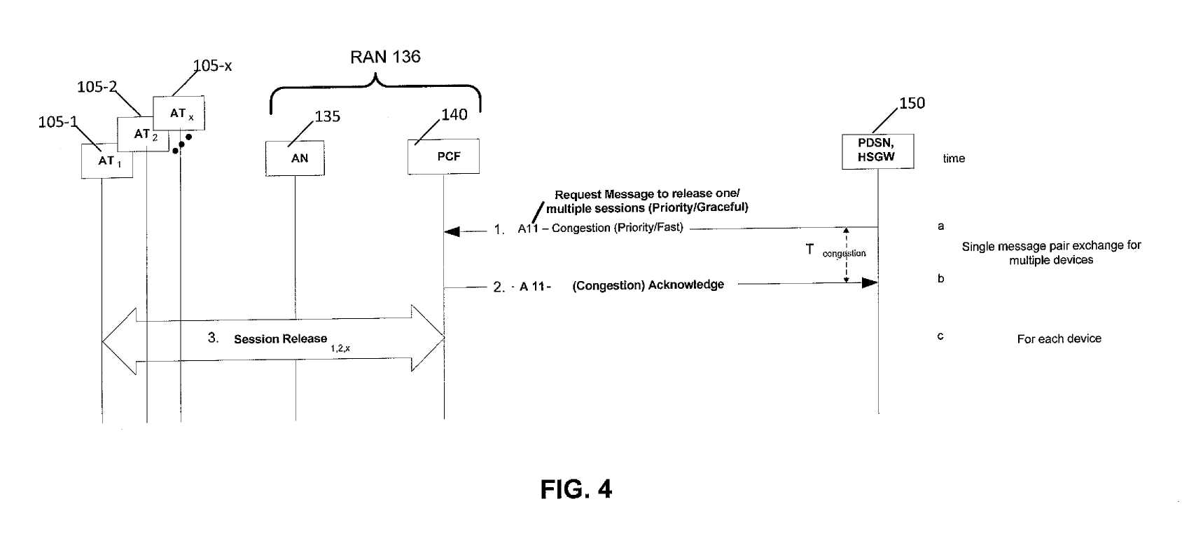

Another exemplary embodiment is shown in FIG. 4. In this embodiment, the congestion message (in operation 1) instructs the RAN 136 to release low priority sessions without further session release signaling to the PDSN or HSGW 150. The instruction uses the “Fast” (e.g., ungraceful) indicator. Normally to release an existing IP session, the RAN 136 must send an A11-Registration Request message with the Lifetime field of the message set to zero to initiate release of each device's IP or packet data session (including accounting records for the calls) followed by an A11-Registration Reply message from the PDSN (or HSGW) 150 confirming the release of the device's mobile IP session and A10 connections. See operations 3 and 4 in FIG. 3. This embodiment in FIG. 4 may be used, e.g., when the PDSN or HSGW 150 traffic or core network traffic has reached a critical threshold and all traffic including signaling needs to be reduced. Thus, after operation 2, there are no message pair exchanges (see operations 3 and 4 in FIG. 3). The PDSN/HSGW releases the A10 connections associated with the packet data session without receiving the A11-Registration Request message signaling from the RAN. In operation 3, the RAN 136 performs session releases, e.g. HRPD air interface session with the ATs 105.

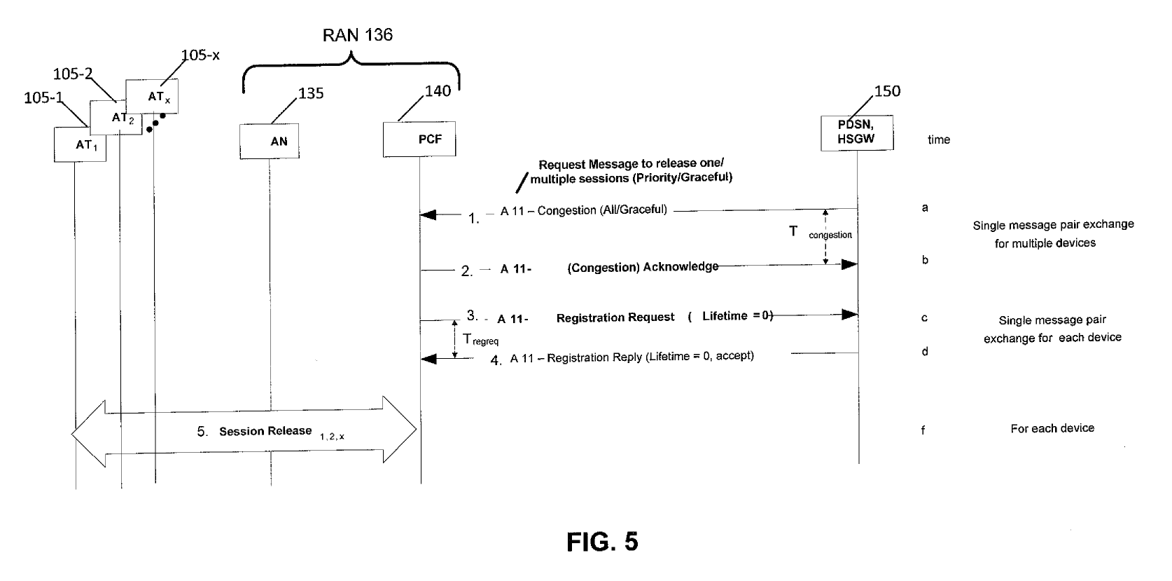

Another exemplary embodiment is shown in FIG. 5. In FIG. 5, the congestion message in operation 1 requests the RAN 136 to release all existing sessions at the PCF to relieve the PDSN, HSGW 150 (e.g., or core network) of congestion to prevent a complete network outage. While this embodiment may be drastic in the sense that all existing sessions at a RAN 136 are released, it is beneficial for the following reasons:

a) All device types, e.g. machine-to-machine or M2M devices may be configured on a single PCF 145 where the message is sent while non-M2M devices may be configured on an alternate PCF 145 whose call sessions are allowed to continue.

b) In the event that case (a) is not applicable, it is better to gracefully release all calls on a particular PCF than to experience a network outage (an example of an outage is described above).

In operation 2, the RAN 136 sends a message indicating congestion acknowledge. A “Graceful” indicator (or lack of a “Fast” indicator) (see operation 1) indicates to the RAN 136 that an individual single message pair exchange (operations 3 and 4) is to be performed for each device (i.e., each AT 105) having a session to be released.

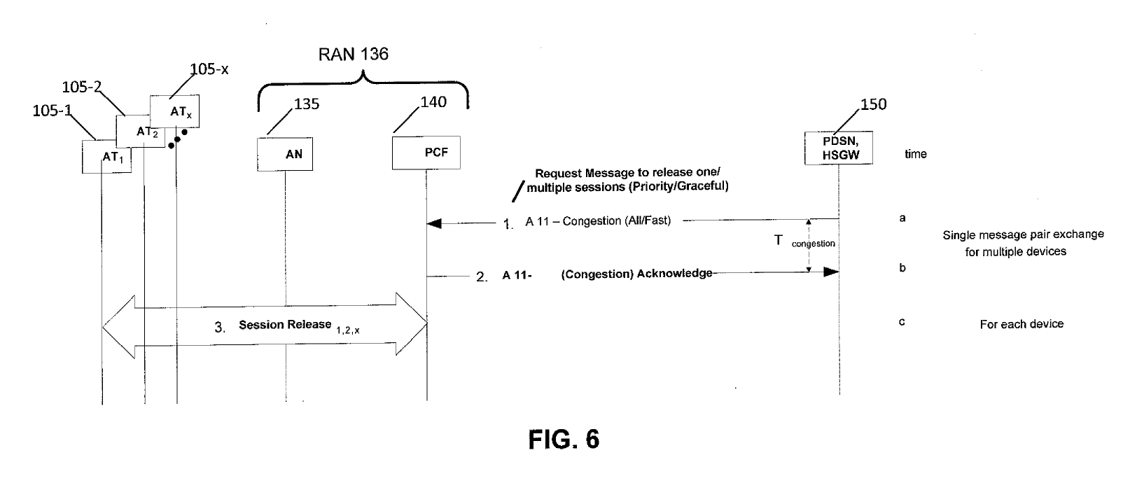

Another embodiment is shown in FIG. 6, where the PDSN/HSGW 150 requests (via the “Fast” indicator in the message in operation 1) all PCFs connected to a PDSN/HSGW to release all existing sessions supported through a particular PDSN/HSGW to relieve the PDSN, HSGW 150 or core network of its congestion to prevent a complete network outage and that no further A11 session release signaling is to be performed (e.g., no single message pair exchanges are performed). This embodiment may be considered to be a combination of the embodiments in FIGS. 4 and 5.

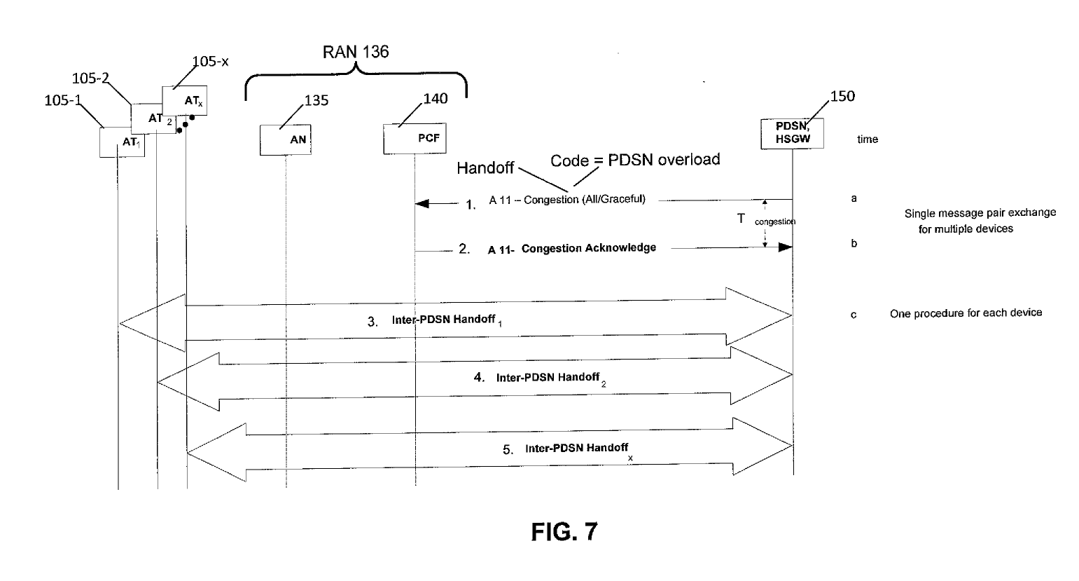

Another embodiment is shown in FIG. 7, where the PDSN/HGSW 150 sends a congestion message to the RAN. The RAN in turn autonomously initiates inter-PDSN/HSGW handoffs for some or all of those sessions which have a priority lower than the priority indication in the message instead of releasing them thereby allowing lower priority calls to continue via another PDSN. It should be noted it may not be possible to perform inter-PDSN handoffs for all of the sessions. In this case, some sessions will be handed off and some will be released. This may result in the RAN initiating inter-PDSN handoffs for all sessions if the message priority is set so high such that all sessions have a lower priority or the message includes an ‘A11’ indication. The PDSN or HSGW may also include a ‘handoff’ indication to explicitly request the RAN to complete inter-PDSN handoffs for some or all packet data sessions based on the priority indication. This may be included if the congestion message in operation 1 was sent as a result of PDSN (or HSGW) 150 overload rather than core network congestion. The PDSN 150 could indicate this congestion via a ‘Code’ message in the congestion message. In operation 2, the RAN 136 acknowledges the congestion via a message comprising an indication of a congestion acknowledge. Each of operations 3, 4, and 5 performs an inter-PDSN (or inter HSGW) handoff of one of the ATs 105 having a priority not meeting the priority criterion (e.g., “priority”) in the method of operation 1.

The PDSN or HSGW initiates congestion relief, in an exemplary embodiment, only if the PCF or RAN indicates that it (the PCF or RAN) supports the congestion relief feature.

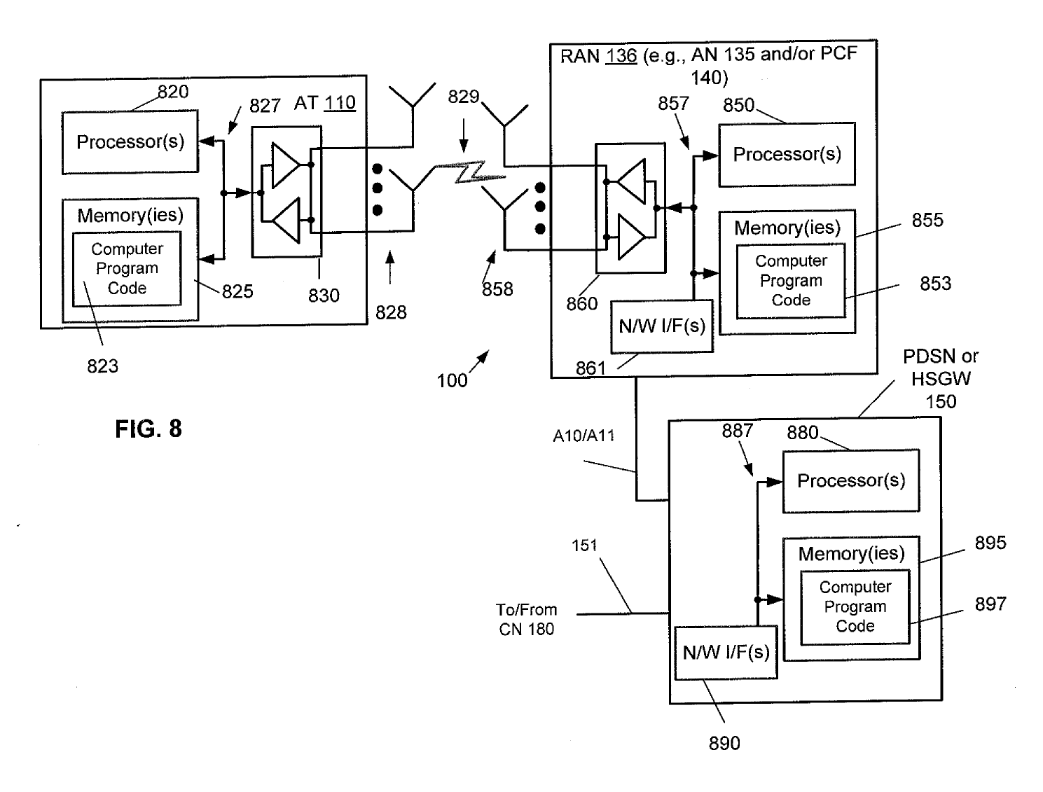

Turning now to FIG. 8, a block diagram is shown of another exemplary system in which the exemplary embodiments may be practiced. The AT 110 is shown in wireless communication via link 829 with the RAN 136. The AT 110 includes one or more processors 820, one or more memories 825, and one or more transceivers 830 (e.g., a dual mode AT might have two transceivers, one for each mode, and a typical wireless device such as a smartphone could have several transceivers 830 such as Bluetooth, Wi-Fi, CDMA, LTE, and the like) connected via one or more buses 827. The one or more transceivers 830 are connected to one or more antennas 828. The one or more memories include computer program code 823. The one or more memories 825 and the computer program code 823 are configured, with the one or more processors 820, to cause the AT 110 to perform one or more of the operations described herein. One or more operations may also be performed by hardware, such as an integrated circuit. Thus, the operations may be performed by the computer program code 823 (executed by the one or more processors 820), hardware, or some combination of these.

The network 100 includes the RAN 136 and the PDSN or HSGW 150. The RAN 136 typically includes both the AN 135 and the RAN 136, and therefore may be considered to operate as a single element in some implementations. In other implementations, the AN 135 and RAN 136 are independently accessible. Each of the AN 135 or RAN 136, depending on implementation, may include one or more processors 850, one or more memories 855, one or more transceivers 860, and one or more network interfaces 861, interconnected through one or more buses 857. The one or more transceivers 860 are connected to one or more antennas 858. The one or more transceivers 860 and the one or more antennas 858 are an RT 166. The one or more memories 855 include computer program code 853. The one or more memories 855 and the computer program code 853 are configured, with the one or more processors 850, to cause the entities (e.g., AN 135 and/or PCF 140) in the RAN 136 to perform one or more of the operations described herein. One or more operations may also be performed by hardware, such as an integrated circuit. Thus, the operations may be performed by the computer program code 853 (executed by the one or more processors 850), hardware, or some combination of these. The one or more network interfaces 861 provide communication over any links (e.g., networks), and may implement, e.g., the A10 or A11 interfaces.

The PDSN or HSGW 150 includes one or more processors 880, one or more memories 895, and one or more network interfaces 890, interconnected through one or more buses 887. The one or more memories 895 include computer program code 897. The one or more memories 895 and the computer program code 897 are configured, with the one or more processors 880, to cause the PDSN or HSGW 150 to perform one or more of the operations described herein. One or more operations may also be performed by hardware, such as an integrated circuit. Thus, the operations may be performed by the computer program code 897 (executed by the one or more processors 880), hardware, or some combination of these. The one or more network interfaces 890 provide communication over any links (e.g., networks) such as link 151, and may implement, e.g., the A10 or A11 interfaces.

Some of these features may be enabled through changes to the “PCF Enabled Features”, and particularly the “Congestion Relief Supported” field in the following. Regarding the following, see “Application Sub Type”, table 4.2.14-1, for A.S0017-C/D, e.g., 3GPP2 A.S0017-D v3.0, “Interoperability Specification (IOS) for cdma2000 Access Network Interfaces—Part 7 (A10 and A11 Interfaces)”, (3G-IOS v5.1.2), which is an updated version of A.S0017-C. The “Application Type” field “indicates the type of application to which the extension relates”, see A.S0017-D. The “Application Sub Type” is a “one octet field [that] indicates the Application sub-type within the Application Type”, see A.S0017-D.

| Application Type | | Application Sub Type | | | |
|---|---|---|---|---|---|
| Name | Value | Name | Value | Used in Message | Reference |
| PCF Enabled Features | 0BH | Short Data Indication | 01H | A11-Registration Request | 3.1 |
| | | Supported | | A11-Capabilities Info | 3.7 |
| | | | | A11-Capabilities Info Ack | 3.8 |
| | | GRE Segmentation | 02H | A11-Registration Request | 3.1 |
| | | Enabled | | A11-Capabilities Info | 3.7 |
| | | | | A11-Capabilities Info Ack | 3.8 |
| | | Congestion Relief | 03H | A11-Registration Request | 3.1 |
| | | Supported | | A11-Capabilities Info | 3.7 |
| | | | | A11-Capabilities Info Ack | 3.8 |

All other values are reserved

As can be seen by reference to A.S0017-D, the “Congestion Relief Supported” application subtype and corresponding value of 03H (03 hexadecimal) are added to the “PCF Enabled Features” Application Type, and may be added to the A11-Registration Request, A11-Capabilities Information, or A11-Capabilities Info Ack messages, e.g., as part of a Normal Vendor/Organization Specific Extension element. See section 4.2.14 of A.S0017-D.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 6. A computer-readable medium may comprise a computer-readable storage medium (e.g., memories 825, 855, and/or 895 or other device) that may be any media or means that can contain or store the instructions for use by or in connection with an instruction execution system, apparatus, or device, such as a computer.

The following exemplary embodiments are now presented via the following items.

1. A method includes: receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and the radio access network in response to the received message releasing all packet data sessions with a subscription priority not meeting the one or more priority criteria and not releasing any packet data session with a subscription priority not meeting the one or more priority criteria.

2. The method of item 1, wherein the message indicates congestion occurs at least at the gateway entity.

3. The method of item 1, wherein the message indicates congestion occurs at least in the core network.

4. The method of item 1, wherein releasing further comprises completing an inter-packet data serving node handoff of the packet data sessions meeting the one or more priority criteria.

5. The method of item 1, wherein the one or more priority criteria is a priority and releasing further comprises releasing all packet data sessions having a subscription priority less than the priority and not releasing any packet data session having a subscription priority not less than the priority.

6. The method of any one of items 1 to 5, wherein the received message comprises an indication packet data sessions are to be released with further signaling to the gateway entity for individual ones of the packet data sessions to be released, and wherein the method further comprises, prior to releasing, performing for each packet data session to be released an exchange of messages corresponding to that packet data session, the exchange indicating that that packet data session is to be released.

7. The method of any one of items 1 to 5, wherein the received message comprises an indication packet data sessions are to be released without further signaling for individual ones of the packet data sessions to be released.

8. The method of item 1, wherein the one or more priority criteria are such that no subscription priority will meet the one or more priority criteria and wherein releasing further comprises releasing all packet data sessions.

9. The method of item 1, wherein the message further comprises an indication all packet data sessions are to be released, and wherein releasing further comprises releasing all packet data sessions.

10. The method of any one of items 8 or 9, wherein the received message comprises an indication packet data sessions are to be released with further signaling to the gateway entity for individual ones of the packet data sessions to be released, and wherein the method further comprises, prior to releasing, performing for each packet data session to be released an exchange of messages corresponding to that packet data session, the exchange indicating that that packet data session is to be released.

11. The method of any one of items 8 or 9, wherein the received message comprises an indication packet data sessions are to be released without further signaling to the gateway entity for individual ones of the packet data sessions to be released.

12. The method of any one of items 1 to 11, wherein the releasing further comprises performing a session release for each packet data session to be released, the session release comprising signaling between the radio access network and a corresponding one of the access terminals.

12A. The method of any one of the preceding items, wherein prior to receiving, the radio access network sends a message indicating the radio access network supports a congestion relief feature.

13. The method of any one of the preceding items, further comprising responding to the received message by sending a message comprising an acknowledgement of the received message to the gateway entity.

14. The method of any one of the preceding items, wherein the radio access network comprises a packet control function.

15. The method of any one of the preceding items, wherein the gateway entity comprises one of a packet data serving node or a high rate packet data serving gateway

16. An apparatus, comprising: one or more processors, and one or more memories including computer program code. The one or more memories and the computer program code are configured to, with the one or more processors, cause the apparatus to perform any one of method items 1 to 15.

17. A computer program product comprising a computer-readable medium bearing computer program code embodied therein for use with a computer, the computer program code comprising code for performing any one of method items 1 to 15.

18. A method includes: a packet data core network gateway entity terminating a packet data session for each of one or more access terminals, wherein each packet data session is associated with a subscription priority; and sending by the core network gateway entity a message comprising a priority field requesting release of all packet data sessions associated with a subscription priority meeting one or more priority criteria corresponding to the priority field and not releasing any packet data session with a subscription priority not meeting the one or more priority criteria.

19. The method of item 18, wherein the message indicates congestion occurs at least at the gateway entity.

20. The method of item 18, wherein the message indicates congestion occurs at least in a core network.

21. The method of item 18, wherein the one or more priority criteria is a priority and the request requests release of all packet data sessions having a subscription priority less than the priority and requests not releasing any packet data session having a subscription priority not less than the priority.

22. The method of item 18, wherein the message comprises an indication packet data sessions are to be released with further signaling for individual ones of the packet data sessions to be released, and wherein the method further comprises performing for each packet data session to be released an exchange of messages corresponding to that packet data session, the exchange indicating that that packet data session is to be released.

23. The method of item 18, wherein the message comprises an indication packet data sessions are to be released without further signaling for individual ones of the packet data sessions to be released.

24. The method of item 18, wherein the one or more priority criteria are such that no subscription priority will meet the one or more priority criteria.

25. The method of item 18, wherein the at least one indication comprises an indication that all packet data sessions are to be released.

26. The method of any one of items 24 or 25, wherein the message comprises an indication packet data sessions are to be released with further signaling for individual ones of the packet data sessions to be released, and wherein the method further comprises performing for each packet data session to be released an exchange of messages corresponding to that packet data session, the exchange indicating that that packet data session is to be released.

27. The method of any one of items 24 or 25, wherein the message comprises an indication packet data sessions are to be released without further signaling for individual ones of the packet data sessions to be released.

27A. The method of any one of the preceding items, further comprising releasing A10 connections for packet data sessions that are released.

27B. The method of any one of the preceding items, wherein sending the message further comprises sending the message including an indication of congestion in the core network gateway entity.

27C. The method of any one of the preceding items, wherein sending the message further comprises sending the message including a request for a radio access network to perform based on the one or more priority criteria inter-packet data serving node handoffs for some or all of the packet data sessions.

27D. The method of any one of the preceding items, further comprising receiving a message indicating a radio access network supports a congestion relief feature.

28. The method of any one of the preceding items, further comprising receiving a message comprising an acknowledgement of the sent message to the gateway entity.

29. The method of any one of the preceding items, wherein the radio access network comprises a packet control function.

30. The method of any one of the preceding items, wherein the gateway entity comprises one of a packet data serving node or a high rate packet data serving gateway

31. An apparatus includes one or more processors and one or more memories including computer program code. The one or more memories and the computer program code are configured to, with the one or more processors, cause the apparatus to perform any one of method items 18 to 30.

32. A computer program product comprising a computer-readable medium bearing computer program code embodied therein for use with a computer, the computer program code comprising code for performing any one of method items 18 to 30.

If desired, the different functions discussed herein may be performed in a different order and/or concurrently with each other. Furthermore, if desired, one or more of the above-described functions may be optional or may be combined.

Although various aspects of the invention are set out above, other aspects of the invention comprise other combinations of features from the described embodiments, and not solely the combinations explicitly set out above.

It is also noted herein that while the above describes example embodiments of the invention, these descriptions should not be viewed in a limiting sense. Rather, there are several variations and modifications which may be made without departing from the scope of the present invention.

What is claimed is:

1. A method, comprising:
receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and
releasing, by the radio access network in response to the received message, all packet data sessions with a subscription priority not meeting the one or more priority criteria.

2. The method of claim 1, wherein the message indicates one of congestion occurs at least at a gateway entity or congestion occurs at least in a core network.

3. The method of claim 1, wherein releasing further comprises completing an inter-gateway handoff of the packet data sessions meeting the one or more priority criteria.

4. The method of claim 1, wherein the one or more priority criteria is a priority and releasing further comprises releasing all packet data sessions having a subscription priority less than the priority.

5. The method of claim 1, wherein the one or more priority criteria are such that no subscription priority will meet the one or more priority criteria and wherein releasing further comprises releasing all packet data sessions.

6. The method of claim 1, wherein the received message comprises an indication packet data sessions are to be released with further signaling to a gateway entity for individual ones of the packet data sessions to be released, and wherein the method further comprises, prior to releasing, performing for each packet data session to be released an exchange of messages corresponding to that packet data session, the exchange indicating that that packet data session is to be released.

7. The method of claim 1, wherein the received message comprises an indication packet data sessions are to be released without further signaling for individual packet data sessions to be released from a gateway entity.

8. The method of claim 1, wherein prior to receiving, the radio access network sends a message indicating the radio access network supports a congestion relief feature, wherein the message indicating the radio access network supports a congestion relief feature has a congestion relief supported indication, and the message indicating the radio access network supports a congestion relief feature comprises one of a registration request message, a capabilities information message, or a capabilities information acknowledge message.

9. The method of claim 1, further comprising responding to the received message by sending a message comprising an acknowledgement of the received message to a gateway entity.

10. The method of claim 1, wherein the radio access network comprises a packet control function that performs at least the receiving the message and the releasing all packet sessions.

11. A computer readable storage medium containing a computer program which program causes a computer to perform the method of claim 1.

12. An apparatus, comprising:
one or more processors; and
one or more memories including computer program code, wherein the one or more memories and the computer program code are configured to, with the one or more processors, cause the apparatus to perform:
receiving, by a radio access network providing service to one or more access terminals and supporting a packet data session for each of the one or more access terminals wherein each packet data session is associated with a subscription priority, a message comprising a priority field and requesting release of all packet data sessions having a subscription priority meeting one or more priority criteria corresponding to the priority field; and
releasing, by the radio access network and in response to the received message, all packet data sessions with a subscription priority not meeting the one or more priority criteria.

13. The apparatus of claim 12, wherein the message indicates one of congestion occurs at least at a gateway entity or congestion occurs at least in a core network.

14. The apparatus of claim 12, wherein releasing further comprises completing an inter-gateway handoff of the packet data sessions meeting the one or more priority criteria.

15. The apparatus of claim 12, wherein the one or more priority criteria is a priority and releasing further comprises releasing all packet data sessions having a subscription priority less than the priority.

16. The apparatus of claim 12, wherein the one or more priority criteria are such that no subscription priority will meet the one or more priority criteria and wherein releasing further comprises releasing all packet data sessions.

17. The apparatus of claim 12, wherein the received message comprises an indication packet data sessions are to be released with further signaling to a gateway entity for individual ones of the packet data sessions to be released, and wherein the one or more memories and the computer program code are further configured to, with the one or more processors, cause the apparatus to perform: prior to releasing, performing for each packet data session to be released an exchange of messages corresponding to that packet data session, the exchange indicating that that packet data session is to be released.

18. The apparatus of claim 12, wherein the received message comprises an indication packet data sessions are to be released without further signaling for individual packet data sessions to be released from a gateway entity.

19. The apparatus of claim 12, wherein prior to receiving, the radio access network sends a message indicating the radio access network supports a congestion relief feature, wherein the message indicating the radio access network supports a congestion relief feature has a congestion relief supported indication, and the message indicating the radio access network supports a congestion relief feature comprises one of a registration request message, a capabilities information message, or a capabilities information acknowledge message.

20. The apparatus of claim 12, wherein the one or more memories and the computer program code are further configured to, with the one or more processors, cause the apparatus to perform: responding to the received message by sending a message comprising an acknowledgement of the received message to a gateway entity.

21. The apparatus of claim 12, wherein the radio access network comprises a packet control function that performs at least the receiving the message and the releasing all packet sessions.

22. A method, comprising:
terminating by a gateway entity a packet data session for each of one or more access terminals, wherein each packet data session is associated with a subscription priority; and
sending by the gateway entity a message comprising a priority field requesting release of all packet data sessions associated with a subscription priority meeting one or more priority criteria corresponding to the priority field.

23. The method of claim 22, wherein the message indicates one of congestion occurs at least at the gateway entity or congestion occurs at least in a core network.

24. The method of claim 22, wherein the one or more priority criteria are such that no subscription priority will meet the one or more priority criteria.

25. The method of claim 22, wherein the one or more priority criteria is a priority and the request requests release of all packet data sessions having a subscription priority less than the priority.

26. The method of claim 22, wherein the message comprises an indication packet data sessions are to be released with further signaling for individual ones of the packet data sessions to be released, and wherein the method further comprises performing for each packet data session to be released an exchange of messages corresponding to that packet data session, the exchange indicating that that packet data session is to be released.

27. The method of claim 22, wherein the message comprises an indication packet data sessions are to be released without further signaling from the gateway entity for individual packet data sessions to be released.

28. The method of claim 22, further comprising receiving a message indicating a radio access network supports a congestion relief feature.

29. The method of claim 22, further comprising receiving a message comprising an acknowledgement of the sent message to the gateway entity.

30. A computer readable storage medium containing a computer program which program causes a computer to perform the method of claim 22.

31. An apparatus, comprising:
one or more processors; and
one or more memories including computer program code, wherein the one or more memories and the computer program code are configured to, with the one or more processors, cause the apparatus to perform:
terminating by a gateway entity a packet data session for each of one or more access terminals, wherein each packet data session is associated with a subscription priority; and
sending by the gateway entity a message comprising a priority field requesting release of all packet data sessions associated with a subscription priority meeting one or more priority criteria corresponding to the priority field.

32. The apparatus of claim 31, wherein the message indicates one of congestion occurs at least at the gateway entity or congestion occurs at least in a core network.

33. The apparatus of claim 31, wherein the one or more priority criteria are such that no subscription priority will meet the one or more priority criteria.

34. The apparatus of claim 31, wherein the one or more priority criteria is a priority and the request requests release of all packet data sessions having a subscription priority less than the priority.

35. The apparatus of claim 31, wherein the message comprises an indication packet data sessions are to be released with further signaling for individual ones of the packet data sessions to be released, and wherein the one or more memories and the computer program code are further configured to, with the one or more processors, cause the apparatus to perform: performing for each packet data session to be released an exchange of messages corresponding to that packet data session, the exchange indicating that that packet data session is to be released.

36. The apparatus of claim 31, wherein the message comprises an indication packet data sessions are to be released without further signaling from the gateway entity for individual packet data sessions to be released.

37. The apparatus of claim 31, further comprising receiving a message indicating a radio access network supports a congestion relief feature.

38. The apparatus of claim 31, further comprising receiving a message comprising an acknowledgement of the sent message to the gateway entity.
